(19) United States
(12) Patent Application Publication
(10) Pub. No.: US 2002/0174076 A1
(43) Pub. Date: Nov. 21, 2002

(54) Search engine and multiple cost analysis for multiple items offered over the internet by different vendors

(76) Inventor: John A. Bertani, Corvallis, OR (US)

Correspondence Address: HEWLETT-PACKARD COMPANY, Intellectual Property Administration, P. O. Box 272400, Fort Collins, CO, 80527-2400, US

(21) Appl. No.: 09/738,075

(22) Filed: Dec. 15, 2000

(51) Int. Cl. G06G 7/00

(52) U.S. Cl. 705/400

(57) ABSTRACT

A method of multiple cost analysis for multiple, different items, comprising: (a) processing a request from a user for multiple, different items; (b) identifying vendors that offer the multiple, different items; (c) identifying the purchase prices of each item from each vendor; (d) identifying shipping and handling costs of all items from each vendor and all items from all combinations of vendors; (e) calculating the total cost of all items from each vendor and all items from all combinations of vendors; (f) identifying the most cost effective purchase of all items; and (g) transmitting to a user the most cost effective purchase of the items. The invention further includes a search engine, service, program and/or server to provide the foregoing multiple cost analysis.

### TECHNICAL FIELD

The present invention relates generally to a search engine and multiple cost analysis for multiple items offered for sale over the Internet by different vendors.

### BACKGROUND OF THE INVENTION

The Internet has provided access to a wide range of information. See U.S. Pat. No. 5,991,756, which is incorporated herein by reference, for further background regarding the Internet and Internet search engines. U.S. Pat. No. 5,991,756 discloses typical search engines. A typical search engine searches for search terms in a candidate document and returns a list of documents which meet the search criteria. For example, a user can send to a search engine or portal a list of multiple stock ticker symbols and receive back from the search engine the prices of the stocks represented by those ticker symbols.

The Internet has also allowed users or consumers to order various products on-line that are offered for sale by different vendors. For example, products such as books, compact disks, digital video disks and toys are frequently purchased by consumers from different vendors over the Internet. In visiting different vendor Internet web sites, a consumer will frequently find that a product will be offered by different vendors at a different price. In some instances, a consumer will find that some vendors offer one product but not another product. Commercially available portals, such as http://mysimon.com and http://www.addall.com, allow a consumer to search the sites of numerous on-line vendors to obtain the lowest price for a single item.

However, many times, consumers have multiple, different items they wish to purchase at one time or at about the same time over the Internet. For example, gift-giving occasions, such as the winter holiday season, is a typical a time when consumers have multiple, different items they wish to purchase over the Internet. Commercially available search engines or portals do not permit a consumer to search for the lowest total price of multiple, different items offered by a single vendor or a set of more than one vendor. Further, commercially available search engines do not permit a consumer to search for the lowest total price offered by a single vendor of multiple, different items that also takes into account each vendor's shipping and handling costs charges to the consumer. Frequently, shipping and handling costs charged to the consumer will be less for multiple items from a single vendor than if the multiple items are ordered from different vendors. In addition, some vendors may offer a lower price on a single item or group of items wherein the lowest total price of multiple, different items is offered not by one vendor, but by a set of more than one vendor. It would be advantageous to consumers to have the ability to transmit to a specialized search engine a list of multiple, different items and receive back from the search engine information that identifies the lowest total cost, including shipping charges, for the multiple, different items from a single vendor or set of more than one vendor.

### SUMMARY OF THE INVENTION

A new search engine and techniques have now been invented that solves the deficiencies in prior search engines and techniques. More specifically, the present invention provides a pricing search engine and multiple cost analysis for multiple, different items offered over the Internet by different vendors. The search engine of the present invention can receive a list of multiple, different items from a consumer, search for the availability of each item from various on-line vendors, and calculate the total cost of the items, including the purchase price and shipping and handling costs from a single vendor and/or set of more than one vendor to the consumer, and provide the consumer with the calculated lowest total cost information.

By using the pricing search engine of the present invention, a consumer only needs to provide the pricing search engine with a list of multiple, different items and receive back from the search engine the lowest total cost information for the desired items. Thus, a consumer no longer needs to search for vendors who offer multiple, different products, then identify the total price of each product from each vendor, then calculate the total cost of purchasing the multiple, different products from a single vendor, including shipping and handling costs, and then calculate whether the lowest total cost can be obtained by purchasing some products from a single vendor and/or from a set of more than one vendor. In other words, the present invention will perform for a consumer a multiple cost analysis to determine the most cost effective purchase of the multiple, different products. The present invention includes a search engine, service, program and/or server to provide this multiple cost analysis. To summarize, the present invention provides consumers with the ability to easily find a set of multiple, different items at the lowest total price.

### BRIEF DESCRIPTION OF THE DRAWINGS

FIG. 1 is a simplified flow chart depicting the steps of a preferred embodiment of the present invention.

FIG. 2 is a simplified depiction of an apparatus for performing the steps of a preferred embodiment of the present invention.

### DETAILED DESCRIPTION OF THE PREFERRED EMBODIMENTS

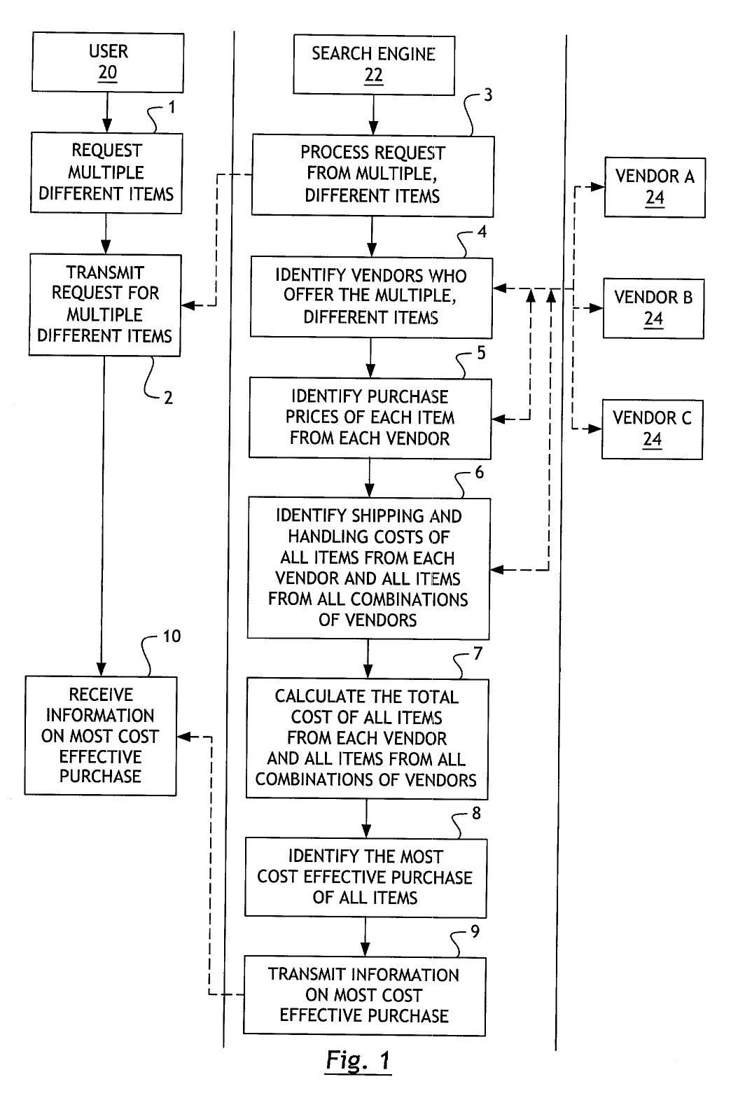

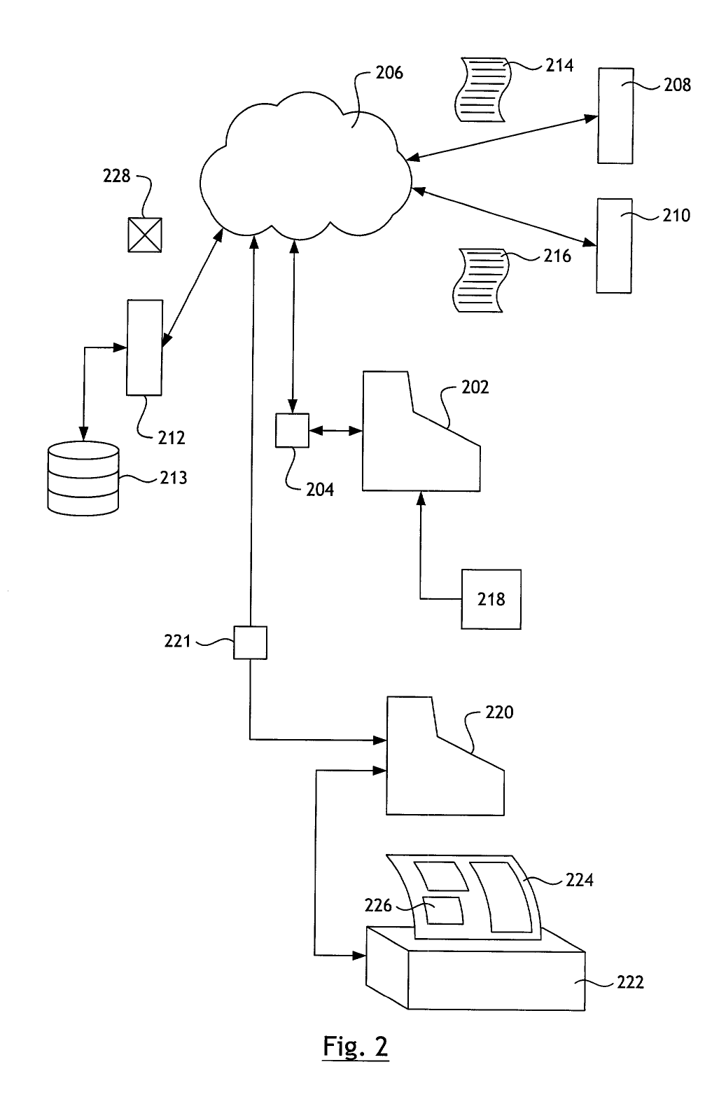

The present invention may be more fully described with reference to FIG. 1 and FIG. 2. As shown in steps 1 and 2 of FIG. 1, a user or consumer 20 can request and transmit via the Internet to a search engine 22 a list of multiple, different items or products desired by the consumer 20. In step 3, search engine 22 processes the request and then in step 4, searches the Internet for vendors 24 (illustrated herein as Vendors A, B, and C) that offer over the Internet any item identified by the user 20. In step 5, search engine 22 identifies the purchase price of each item. In step 6, the search engine 22 identifies the total shipping and handling costs of all the items offered by each vendor and all items from all combinations of vendors. In step 7, the search engine 22 calculates the total cost of all of the items from each vendor and all items from all combinations of vendors, including the purchase price of each item and the shipping and handling costs of all of the items. In step 8, the search engine 22 identifies the most cost effective purchase of all the items. In step 9, search engine 22 provides the user 20 with the calculated information, including the most cost effective purchase of all of the items from one vendor and or set of more than one vendor.

Search engine 22 can further identify the anticipated receipt date by the customer of the items from each vendor and provide that information to user 20. Search engine 22 can provide the most cost effective purchase(s) for the items in descending order, and/or in the order of most cost effective purchase if all of the items from a single vendor.

Search engine 22 can also provide user 20 with access to a simple “click on” web address of the vendor or set of more than one vendor having the lowest total price of the desired items, so that the user 20 can easily click on that web address(es) to make the desired purchase.

FIG. 2 is a simplified depiction of an apparatus by which the method of the present invention might be performed. A data or computer network 206, such as the world wide web of the Internet, links the computers, web page servers or other functional processors 208, 210, and 212 of several on-line vendors to the computer or web server or other processor 202 of a search engine. Each of the servers 208, 210, 212 typically corresponds to a web site of a different vendor, although alternate embodiments might include having one computer provide multiple web sites as well as having a single web site provided by a cooperative action of several computers.

In FIG. 2, a user 20 can transmit from a device 220 a list of multiple, different items to computer 202 via the data network 206. Device 220 can be any device, e.g., a computer, capable of transmitting and receiving information via the Internet or data network 206. Computer 202 of the search engine can then perform the steps depicted in FIG. 1.

In FIG. 2, a web server for an on-line vendor (which would include a wholesale distributor, mass merchandiser or retailer) that provides to its on-line purchasers a shared and collaborative on-line shopping cart, is represented by a computer identified by reference numeral 212. Coupled to the server 212 is a mass storage device 213. The mass storage device 213, typically a hard disk or drives, stores both application programs and data. Because the server 212 is a web server, application programs stored on the disk 213 can include the program(s) and data that generate images and text for the on-line vendor's web site. The disk 213 will also typically store user (e.g., a customer or service subscriber) and product offering information (data), such as purchase price, shipping and handling costs, and anticipated delivery time from the time an order is made by a user. The disk 213 can also store product selection information, i.e., information identifying goods and services selected by a user, prospective customer or subscriber.

Product information stored in a database on the disk 213 might include pictures and narrative descriptions of the various items being offered by the on-line vendor. The mass storage device 213 might also store other information in the same or other databases, which includes the identity of individuals who are registered with the on-line vendor, or who are otherwise authorized to make purchases on-line. Such a database might also store the identity of individuals whom purchase or product/service acquisition data can be shared, contact information (e-mail addresses, pager numbers), login ID and passwords, the company that an individual works for, credit or purchasing limits, an on-line basket ID as well as the items that might have previously been purchased or are under consideration for purchase, i.e., the current contents of the metaphorical shopping basket. The foregoing is all considered to be predetermined subscriber data and information. Data records and information, identified by reference numerals 214, 216, and 228, can be stored on the servers 208, 210 and 212, respectively, in any appropriate form.

The data records and information 214, 216, and 228 can be transferred from the servers 208, 210 and 212 via the data network 206 to the computer 202 of a search engine for processing in accordance with the steps depicted in FIG. 1. After search engine 22 performs the steps shown in FIG. 1, the computer 202 of search engine 22 can then transfer information regarding the most cost effective purchase of multiple, different items to device 220 of a user 20 via the computer network 206.

Information, such as advertisements, identified by reference numeral 218 can also be provided to computer 202, which can transfer that information to device 220 via the data computer network 206.

After the data records and information 214, 216, 228, and 218 are collected and processed by computer 202, and the most cost effective purchase for multiple, different items is calculated by computer 202, the information on the most cost effective purchase is sent via the Internet or data network 206 through an appropriate interface (dial up modem, Ethernet or other mechanism) 204 to the data network 206 for delivery to the user's device 220 through appropriate transmission media 221 (and interface).

Device 220 can be operatively connected to a printer 222, and purchase information 226, including the most cost effective purchase of multiple, different items can be printed on paper 224.

Web page servers 208, 210 and 212 might be owned, operated and/or controlled by an Internet service provider, which simply provides distribution capacity for the real on-line vendor 24. In such an alternate embodiment, the ISP performs the role of the putative on-line vendor by distributing or making available vendor information, including items offered by the vendor, purchase price, shipping and handling charges and anticipated delivery time of an item or items to a user 20 from date of order. For purposes of claim construction, a “vendor” should therefore be construed to include an Internet service provider as well. The vendor information 226 is delivered to users of the present invention (the device or computer of one such user 20 is shown and identified by reference numeral 220) for display on a computer or print out onto a page 224 at the user's local printer 222.

The present invention is further described in the following examples.

### EXAMPLE 1

In this example, a user 20 desires to purchase two compact disks (CD1 and CD2), one digital video disk (DVD), and two books (Book1 and Book2) at the lowest price from a single vendor. User 20 can identify and transmit the list of desired items to a search engine 22, as shown in steps 1 and 2 of FIG. 1. Search engine 22 processes the request and searches the Internet for vendors 24 that offer the desired items (see steps 3 and 4 of FIG. 1). For the purposes of this example, three vendors (Vendor A, Vendor B, and Vendor C) are identified by search engine 22. Search engine 22 also identifies the purchase price of each item and the shipping and handling (S & H) costs of all of the desired items (see steps 5 and 6 of FIG. 1). At step 6, search engine 22 can also calculate and/or list the total purchase price of the set of multiple, different items as offered by each vendor, such as shown the following Table 1.

TABLE 1

| Vendor A | | Vendor B | | Vendor C | |
|---|---|---|---|---|---|
| CD1 | 12.60 | CD1 | 12.40 | CD1 | 12.00 |
| CD2 | 13.95 | CD2 | 16.95 | CD2 | 16.00 |
| DVD | 45.00 | DVD | 47.00 | DVD | 49.95 |
| Book1 | 16.45 | Book1 | 12.45 | Book1 | 12.45 |
| Book2 | 22.25 | Book2 | 19.25 | Book2 | 23.10 |
| Sub-total | $110.25 | Sub-total | $108.05 | Sub-total | $113.25 |
| S & H | 15.00 | S & H | 12.50 | S & H | 17.00 |
| Total | $125.25 | Total | $120.55 | Total | $130.50 |

| | | |
|---|---|---|
| Delivery time: 4 days | Delivery time: 3 days | Delivery time: 3 days |

As shown in Table 1, the lowest total cost of all five items is offered from Vendor B. Search engine 22 can provide to user 20 all of the information in Table 1, and/or identify only some of the information in Table 1, such as the lowest total cost and from which vendor. Search engine 22 can also provide a click button that will take the user 20 to the vendor that can provide the items at the lowest total cost. If information on the timing of the delivery to the user from each vendor is desired, search engine 22 can also locate from each vendor this information and provide that information to user 20. As shown in Table 1, the delivery time to user 20 from the time of order of the items from each vendor may also be provided by search engine 22 to user 20.

### EXAMPLE 2

At steps 6 and 7, search engine 22 can also calculate the total lowest cost of the desired items from a set of vendors. As shown in Table 2, the total lowest cost of the desired items can be attained if CD2 and the DVD are ordered from Vendor A, and CD1 and Book1 and Book2 are ordered from Vendor B. The total lowest cost for all of the items is $107.45. This information can be identified and transmitted to user 20 as shown in steps 8 and 9 of FIG. 1. User 20 would process this information in step 10 as shown in FIG. 1. In this example, user 20 could obtain all of the items for a total cost of $107.45, which would result in a total cost savings of $13.10 as opposed to the total cost if all five items are ordered from Vendor B.

TABLE 2

| Vendor A | | Vendor B | |
|---|---|---|---|
| CD2 | 13.95 | CD1 | 12.40 |
| DVD | 45.00 | Book1 | 12.45 |
| Sub-total | $58.95 | Book2 | 19.25 |
| S & H | 8.00 | Sub-total | $34.05 |
| Total | $66.95 | S & H | 6.45 |
| Delivery time: 4 days | | Total | $40.50 |
| | | Delivery time: 3 days | |

Total: $66.95 + $40.50 = $107.45

The present invention as described above provides a method by which a consumer can simply transmit to a search a list of multiple, different items, and receive back from the search engine an identification of the lowest cost of all of the items from a single vendor and/or set of more than one vendor. The search engine 22 of the present invention can include a microprocessor or computer which can be readily programmed by those skilled in the art and/or include a program to carry out the techniques of the present invention, including the multiple cost analysis of desired items.

The present invention includes a search engine, service, program, and/or server for providing the foregoing multiple cost analysis.

What has been described above is merely illustrative of the application of the principles of the present invention. Those skilled in the art can implement other arrangements and methods without departing from the spirit and scope of the present invention.

What is claimed is:

1. A search engine adapted to (a) process a request for multiple, different items; (b) identify vendors that offer the multiple, different items; (c) identify the purchase prices of each item from each vendor; (d) identify shipping and handling costs of all items from each vendor and all items from all combinations of vendors; (e) calculate the total cost of all items from each vendor and all items from all combinations of vendors; (f) identify the most cost effective purchase of all items; and (g) transmit to a user information on the most cost effective purchase of the items.

2. The search engine of claim 1, further adapted to identify an anticipated delivery date of the items from each vendor to a user.

3. A search engine adapted to (a) process a request for multiple, different items; (b) identify vendors that offer the multiple, different items; (c) identify the purchase prices of each item from each vendor; (d) identify shipping and handling costs of all items from each vendor; (e) calculate the total cost of all items from each vendor; (f) identify the most cost effective purchase of all items; and (g) transmit to a user information on the most cost effective purchase of the items.

4. The search engine of claim 3, further adapted to identify an anticipated delivery date of the items from each vendor to a user.

5. A method of multiple cost analysis for multiple, different items, comprising: (a) processing a request from a user for multiple, different items; (b) identifying vendors that offer the multiple, different items; (c) identifying the purchase prices of each item from each vendor; (d) identifying shipping and handling costs of all items from each vendor and all items from all combinations of vendors; (e) calculating the total cost of all items from each vendor and all items from all combinations of vendors; (f) identifying the most cost effective purchase of all items; and (g) transmitting to a user information on the most cost effective purchase of the items.

6. The method of claim 5, further comprising the step of identifying an anticipated delivery date of the items from each vendor to a user.

7. A method of multiple cost analysis for multiple, different items, comprising: (a) processing a request for multiple, different items; (b) identifying vendors that offer the multiple, different items; (c) identifying the purchase prices of each item from each vendor; (d) identifying shipping and handling costs of all items from each vendor; (e) calculating the total cost of all items from each vendor; (f) identifying the most cost effective purchase of all items; and (g) transmitting to a user information on the most cost effective purchase of the items.

8. The method of claim 7, further comprising the step of identifying an anticipated delivery date of the items from each vendor to a user.

9. A service for providing multiple cost analysis for multiple, different items, comprising: (a) processing a request from a user for multiple, different items; (b) identifying vendors that offer the multiple, different items; (c) identifying the purchase prices of each item from each vendor; (d) identifying shipping and handling costs of all items from each vendor and all items from all combinations of vendors; (e) calculating the total cost of all items from each vendor and all items from all combinations of vendors; (f) identifying the most cost effective purchase of all items; and (g) transmitting to a user information on the most cost effective purchase of the items.

10. The service of claim 9, further comprising identifying an anticipated delivery date of the items from each vendor to a user.

11. A service for providing multiple cost analysis for multiple, different items, comprising: (a) processing a request for multiple, different items; (b) identifying vendors that offer the multiple, different items; (c) identifying the purchase prices of each item from each vendor; (d) identifying shipping and handling costs of all items from each vendor; (e) calculating the total cost of all items from each vendor; (f) identifying the most cost effective purchase of all items; and (g) transmitting to a user information on the most cost effective purchase of the items.

12. The service of claim 11, further comprising identifying an anticipated delivery date of the items from each vendor to a user.

13. A program for providing multiple cost analysis for multiple, different items, comprising: (a) processing a request from a user for multiple, different items; (b) identifying vendors that offer the multiple, different items; (c) identifying the purchase prices of each item from each vendor; (d) identifying shipping and handling costs of all items from each vendor and all items from all combinations of vendors; (e) calculating the total cost of all items from each vendor and all items from all combinations of vendors; (f) identifying the most cost effective purchase of all items; and (g) transmitting to a user information on the most cost effective purchase of the items.

14. The program of claim 13, further comprising identifying an anticipated delivery date of the items from each vendor to a user.

15. A program for providing multiple cost analysis for multiple, different items, comprising: (a) processing a request for multiple, different items; (b) identifying vendors that offer the multiple, different items; (c) identifying the purchase prices of each item from each vendor; (d) identifying shipping and handling costs of all items from each vendor; (e) calculating the total cost of all items from each vendor; (f) identifying the most cost effective purchase of all items; and (g) transmitting to a user information on the most cost effective purchase of the items.

16. The program of claim 15, further comprising identifying an anticipated delivery date of the items from each vendor to a user.

17. A server for providing multiple cost analysis for multiple, different items, comprising: (a) processing a request from a user for multiple, different items; (b) identifying vendors that offer the multiple, different items; (c) identifying the purchase prices of each item from each vendor; (d) identifying shipping and handling costs of all items from each vendor and all items from all combinations of vendors; (e) calculating the total cost of all items from each vendor and all items from all combinations of vendors; (f) identifying the most cost effective purchase of all items; and (g) transmitting to a user information on the most cost effective purchase of the items.

18. The server of claim 17, further comprising identifying an anticipated delivery date of the items from each vendor to a user.

19. A server for providing multiple cost analysis for multiple, different items, comprising: (a) processing a request for multiple, different items; (b) identifying vendors that offer the multiple, different items; (c) identifying the purchase prices of each item from each vendor; (d) identifying shipping and handling costs of all items from each vendor; (e) calculating the total cost of all items from each vendor; (f) identifying the most cost effective purchase of all items; and (g) transmitting to a user information on the most cost effective purchase of the items.

20. The server of claim 19, further comprising identifying an anticipated delivery date of the items from each vendor to a user.
